(19) United States
(12) Patent Application Publication
(10) Pub. No.: US 2023/0401622 A1
(43) Pub. Date: Dec. 14, 2023

(54) SYSTEMS AND METHODS FOR GENERATING FULFILLMENT INTERFACES INCLUDING AUTOMATIC FULFILLMENT DETERMINATION

(71) Applicant: Walmart Apollo, LLC, Bentonville, AR (US)

(72) Inventors: Siddharth Rao, San Mateo, CA (US); Sony Mangalassery Gregory, Pleasanton, CA (US); Mangala Mathe, Dublin, CA (US); Kannan Chellappa, San Jose, CA (US); Eric Nelson Elem, Milpitas, CA (US); Mengzeng Rao, Sunnyvale, CA (US); Sriram Uppuluri, Dublin, CA (US); Kurt Swanson, Belmont, CA (US); Keshav Agrawal, New York, NY (US); Arpit Agrawal, San Mateo, CA (US); Anilkumar Garikepati, Fremont, CA (US); Balaji Sangabattuni, Cupertino, CA (US); Justin Jose, Mountain House, CA (US)

(21) Appl. No.: 18/330,511

(22) Filed: Jun. 7, 2023

Related U.S. Application Data
(60) Provisional application No. 63/366,018, filed on Jun. 8, 2022.

(51) Int. Cl. G06Q 30/0601

(52) U.S. Cl. CPC G06Q 30/0621; G06Q 30/0641

(57) ABSTRACT

Systems and methods of generating a fulfillment interface are disclosed. A request for a fulfillment interface is received from a first device. The request identifies a plurality of items for an order. Fulfillment options are determined for each of the items and a first fulfillment plan including a first fulfillment option for a first set of items and a second fulfillment option for a second set of items is generated. The first and second fulfillment options are generated based on the fulfillment options of the corresponding set of items and a customer intent. The fulfillment interface including the first fulfillment plan is generated and transmitted to the first device for display. The interface includes a first portion identifying the first fulfillment option and each of the first set of items and a second portion identifying the second fulfillment option and each of the second set of items.

### CROSS-REFERENCE TO RELATED APPLICATIONS

This application claims benefit under 35 U.S.C. § 119 to U.S. Provisional Appl. Ser. No. 63/366,018, filed 8 Jun. 2022, entitled “Methods and Apparatus for Automatic Fulfillment Determination,” the disclosure of which is incorporated herein by reference in its entirety.

### TECHNICAL FIELD

The disclosure relates generally to interface generation and, more specifically, to interface generation including automated processes for determining and providing fulfillment options.

### BACKGROUND

Retailers may provide customers various fulfillment options when items are purchased. For example, a retailer may offer a customer the option of picking up purchased items at a retail location, or of delivery of the purchased items to the customer's home. When, for instance, a customer purchases an item on a retailer's website, the customer may have the option of choosing whether to have the item delivered, or whether to pick up the item at a local location of the retailer. Customers may have varying preferences for merchandise fulfillment, and purchased items may be better suited for one fulfillment option over another. There are opportunities to improve current fulfillment systems.

### SUMMARY

Customers may purchase grocery items (e.g., fruits, meats, drinks, canned foods, etc.) and/or general merchandise (GM) items (e.g., bikes, clothing, furniture, athletic equipment, etc.) from a same retailer, such as from the retailer's website. The retailer may offer the customer various fulfillment options for the items. One option may be a scheduled delivery, where the customer selects a date (e.g., day and time slot) for delivery. Another option may be an unscheduled delivery, where the retailer attempts to deliver purchased items by a certain date (e.g., 3 days from purchase). Yet another option may be a scheduled pickup, where the customer selects a date (e.g., day and time slot) for pickup, and a pickup location (e.g., local retail location). Further, another option may include unscheduled pickup, where the customer selects to pick up the purchased items at a pickup location without specifying a particular date. In some examples, customers may purchase grocery items of varying types (e.g., refrigerated items, frozen items, and canned items) in a same order, or may purchase both grocery and GM items in a same order. These types of orders may present several complications such as the choice of multiple fulfillment options and varying item fulfillment possibilities. For instance, unification of the customer experience for the situation when grocery and GM items are purchased together presents various fulfillment challenges.

The embodiments described herein may automatically determine a fulfillment (e.g., a default fulfillment) for purchased items based on determined customer preferences and attributes of the purchased items. The embodiments may determine a “best-fit” fulfillment plan that addresses possibly competing considerations on, for example, customer intent, fulfillment speed, customer convenience, cost to the customer, and cost to the retailer, among others. Further, the embodiments may provide an option to switch to an alternative fulfillment option if the customer prefers to do so. The embodiments provide a fulfillment system that unifies the grocery and GM shopping experience while reducing a cognitive load of decision making for the customer, while also balancing between providing the customer with fulfillment flexibility and guided experience. Persons of ordinary skill in the art having the benefit of these disclosures would recognize these and other benefits as well.

In accordance with various embodiments, exemplary systems may be implemented in any suitable hardware or hardware and software, such as in one or more suitable computing devices. For example, in some embodiments, a computing device (e.g., server) comprising at least one processor receives a request identifying a plurality of items for an order of a customer. The computing device determines, for each of the plurality of items, at least one fulfillment option. Based on the at least one fulfillment options for each of the plurality of items and an intent of the customer, the computing device determines a first fulfillment option for the order. Further, the computing device provides the first fulfillment option for the order for display.

In some examples, the computing device determines a second fulfillment option based on the at least one fulfillment options for each of the plurality of items, the intent of the customer, and the first fulfillment option. The computing device may further provide the second fulfillment option for display. In some examples, the computing device receives a selection of at least one of the first fulfillment option and the second fulfillment option. The computing device may generate a fulfillment selection message identifying an item fulfillment option for the plurality of items based on the selection of the at least one of the first fulfillment option and the second fulfillment option. The computing device may also transmit the fulfillment selection message to another computing device for fulfillment of the order.

In some embodiments, a method by at least one processor includes receiving a request identifying a plurality of items for an order of a customer. The method includes determining, for each of the plurality of items, at least one fulfillment option. Based on the at least one fulfillment options for each of the plurality of items and an intent of the customer, the method includes determining a first fulfillment option for the order. Further, the method includes providing the first fulfillment option for the order for display.

In some examples, the method includes determining a second fulfillment option based on the at least one fulfillment options for each of the plurality of items, the intent of the customer, and the first fulfillment option. The method may also include providing the second fulfillment option for display. In some examples, the method includes receiving a selection of at least one of the first fulfillment option and the second fulfillment option. The method may include generating a fulfillment selection message identifying an item fulfillment option for the plurality of items based on the selection of the at least one of the first fulfillment option and the second fulfillment option. The method may also include transmitting the fulfillment selection message to another computing device for fulfillment of the order.

In some embodiments, a non-transitory computer readable medium has instructions stored thereon. The instructions, when executed by at least one processor, cause a device to perform operations that include receiving a request identifying a plurality of items for an order of a customer. The operations include determining, for each of the plurality of items, at least one fulfillment option. Based on the at least one fulfillment options for each of the plurality of items and an intent of the customer, the operations include determining a first fulfillment option for the order. Further, the operations include providing the first fulfillment option for the order for display.

In some examples, the operations include determining a second fulfillment option based on the at least one fulfillment options for each of the plurality of items, the intent of the customer, and the first fulfillment option. The operations may also include providing the second fulfillment option for display. In some examples, the operations include receiving a selection of at least one of the first fulfillment option and the second fulfillment option. The operations may include generating a fulfillment selection message identifying an item fulfillment option for the plurality of items based on the selection of the at least one of the first fulfillment option and the second fulfillment option. The operations may also include transmitting the fulfillment selection message to another computing device for fulfillment of the order.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item fulfillment system in accordance with some embodiments;

FIG. 2 is a block diagram of an exemplary item fulfillment computing device in accordance with some embodiments;

FIGS. 3A and 3B illustrate fulfillment plans in accordance with some embodiments;

FIG. 4A illustrates a prior art fulfillment method;

FIG. 4B illustrates fulfillment options in accordance with some embodiments;

FIG. 5 illustrates a process for determining fulfillment options in accordance with some embodiments;

FIG. 6 illustrates a table mapping item types to fulfillment options in accordance with some embodiments;

FIG. 7 illustrates a block diagram of functional modules that can be implemented by the item fulfillment computing device of FIG. 1 to determine fulfillment options in accordance with some embodiments;

FIGS. 8A, 8B, 8C, 8D, 8E, and 8F illustrate portions of a webpage in accordance with some embodiments;

FIG. 9A illustrates a mapping of items of an order to one or more fulfillment options in accordance with some embodiments;

FIG. 9B illustrates fulfillment options for the order of FIG. 9A in accordance with some embodiments;

FIG. 10 illustrates a ranking of fulfillment options for each of a plurality of plans in accordance with some embodiments; and

FIGS. 11A, 11B, and 11C illustrate mapping tables in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” coupled, “operatively coupled,” operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The unification of the customer experience for grocery and general merchandise (GM) items presents several complications such as the choice of multiple fulfillment options and varying item fulfillment eligibilities. Taking into consideration these complexities, the embodiments may determine best-fit fulfillment plans that address competing considerations on customer intent, speed, customer convenience, cost to the customer, and cost to retailer. The embodiments may determine customer related inputs such as customer intent, address, associated stores, reserved slots, and items in a checkout basket, and may further determine supply chain network state, capacities, and capabilities, and applies logic (e.g., sequential rule-based or machine learning based algorithms) to determine a best-fit fulfillment plan for a given basket (e.g., order). The logic may apply fulfillment prioritization plans and plan mapping templates to comprehensively address all possible combinatorial use cases that can arise due to a customer selecting varying combinations of item types.

In some examples, a system creates a best-fit order fulfillment plan based on customer's experience on multiple e-commerce platforms (grocery and/or merchandise). The system unifies multiple e-commerce platforms to perform order consolidation. The system considers customer related inputs such as customer intent, address, associated stores, reserved slots, and/or items in the basket. The system maps the customer related inputs with supply chain network state, capacities and/or capabilities such as item/node eligibilities, inventory availability, and/or capacity availability. The system runs sequential rule-based logic (e.g., algorithms) to provide the best-fit fulfillment plan for a given basket context. The system runs multiple basic fulfillment prioritization plans and plan mapping templates to address all varying combinations of item types based on the customer's selection. The plans capture heuristics-based rank order priority of fulfillment options to suit the customer's preferences. The system provides omnichannel fulfillment options to the customer on a single platform.

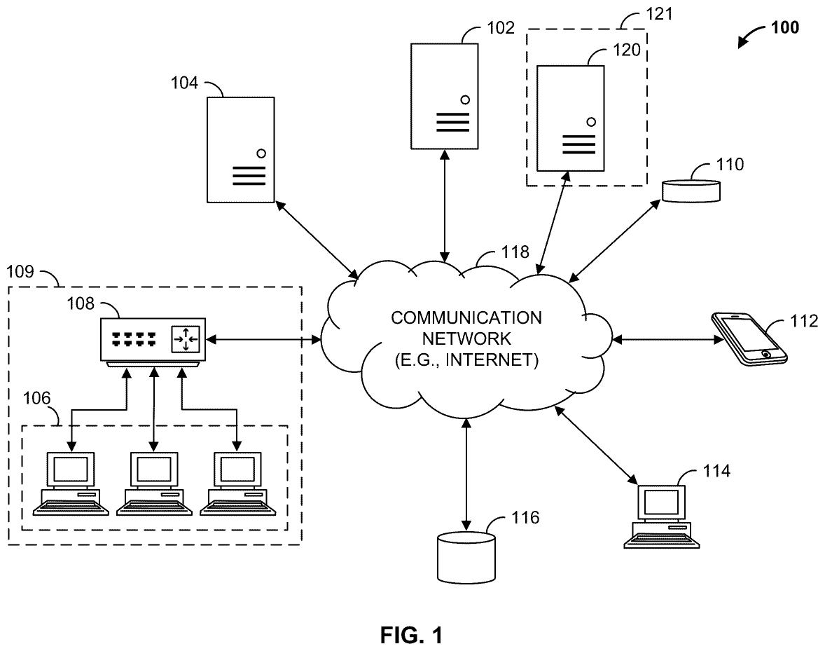

Turning to the drawings, FIG. 1 illustrates a block diagram of an item fulfillment system 100 that includes item fulfillment computing device 102 (e.g., a server, such as an application server), web server 104, workstation(s) 106, database 116, third-party server 120, and multiple customer computing devices 110, 112, 114 operatively coupled over network 118. Item fulfillment computing device 102, workstation(s) 106, web server 104, third-party server 120, and multiple customer computing devices 110, 112, 114 can each be any suitable computing device that includes any hardware or hardware and software combination for processing data. For example, each of item fulfillment computing device 102, web server 104, workstations 106, and multiple customer computing devices 110, 112, 114 can include one or more processors (e.g., each processor including one or more processing cores), one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, each of item fulfillment computing device 102 and third-party server 120 can be a computer, a workstation, a laptop, a server such as a cloud-based server, a distributed computing system, or one or more of any other suitable device. Each of multiple customer computing devices 110, 112, 114 can be a mobile device such as a cellular phone, a laptop, a computer, a table, a personal assistant device, a voice assistant device, a digital assistant, or any other suitable device.

Although FIG. 1 illustrates three customer computing devices 110, 112, 114, item fulfillment system 100 can include any number of customer computing devices 110, 112, 114. Similarly, item fulfillment system 100 can include any number of workstation(s) 106, item fulfillment computing devices 102, third-party servers 120, web servers 104, and databases 116.

Workstation(s) 106 are operably coupled to communication network 118 via router (or switch) 108 Workstation(s) 106 and/or router 108 may be located at a store 109, for example. In some examples, workstation 106 is a register at store 109. Workstation(s) 106 can communicate with item fulfillment computing device 102 over communication network 118. The workstation(s) 106 may send data to, and receive data from, item fulfillment computing device 102. For example, the workstation(s) 106 may transmit data related to a transaction, such as a purchase transaction, to item fulfillment computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104 through, for example, an Application Programming Interface (API).

Database 116 can be a remote storage device, such as a cloud-based server, a memory device on another application server, a networked computer, or any other suitable remote storage. Item fulfillment computing device 102 is operable to communicate with database 116 over communication network 118. For example, item fulfillment computing device 102 can store data to, and read data from, database 116. For instance, item fulfillment computing device 102 may store catalog information for a plurality of items, such as items sold at store 109 or on a website hosted by web server 104, within database 116. The catalog information can include, for each of the items, one or more of an item name, and item brand, an item price, an item description, an item category, or any other item attribute or information. Although shown remote to item fulfillment computing device 102, in some examples, database 116 can be a local storage device, such as a hard drive, a non-volatile memory, or a USB stick.

Communication network 118 can be a WiFi network, a cellular network such as a 3GPP@ network, a Bluetooth@ network, a satellite network, a wireless local area network (LAN), a network utilizing radiofrequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and Nth customer computing device 114 may communicate with web server 104 over communication network 118. For example, web server 104 may host one or more webpages of a website. Each of multiple computing devices 110, 112, 114 may be operable to view, access, and interact with the webpages hosted by web server 104. In some examples, web server 104 hosts a web page for a retailer that allows for the purchase of items. For example, an operator of one of multiple computing devices 110, 112, 114 may access the web page hosted by web server 104, add one or more items to an online shopping cart of the web page, and perform an online checkout of the shopping cart to purchase the items.

Third-party server 120 may provide third-party data, such as information about items. For example, a third-party 121, such as a merchant, manufacturer, third-party seller, or a distributor, may maintain a catalog of items within third-party server 120. In some instances, third-party server 120 transmits information regarding items, such as new items, that a retailer may offer to sell. For example, third-party server 120 may transmit a list of items, along with corresponding item information about each item, to item fulfillment computing device 102.

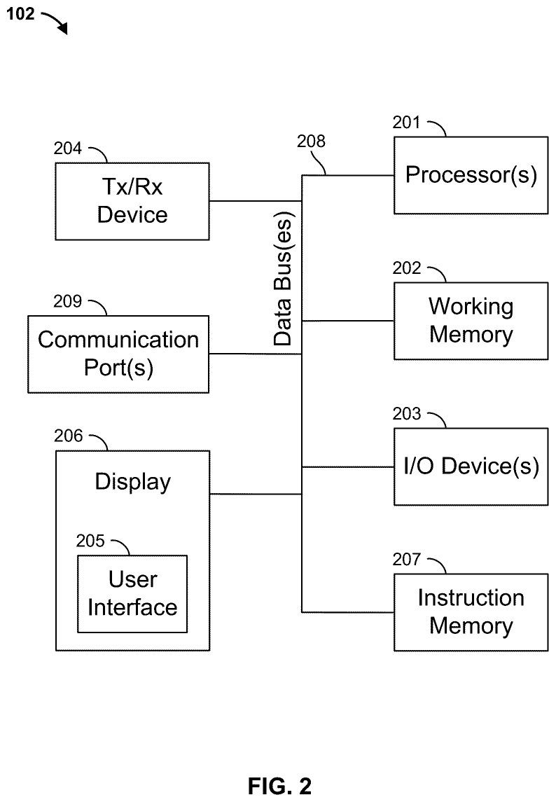

FIG. 2 illustrates an exemplary item fulfillment computing device 102 of FIG. 1. Item fulfillment computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can store instructions that, when executed by one or more processors 201, cause the one or more processors 201 to perform any of the operations described herein, including training and executing any of the machine learning processes described herein. Instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item fulfillment computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as transaction data.

Display 206 can display user interface 205. User interfaces 205 can enable user interaction with item fulfillment computing device 102. For example, user interface 205 can be a user interface for an application of a retailer that allows a customer to purchase one or more items from the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item fulfillment computing device 102 will be operating in. Processor(s) 201 is operable to receive data from, or send data to, a network, such as communication network 118 of FIG. 1, via transceiver 204.

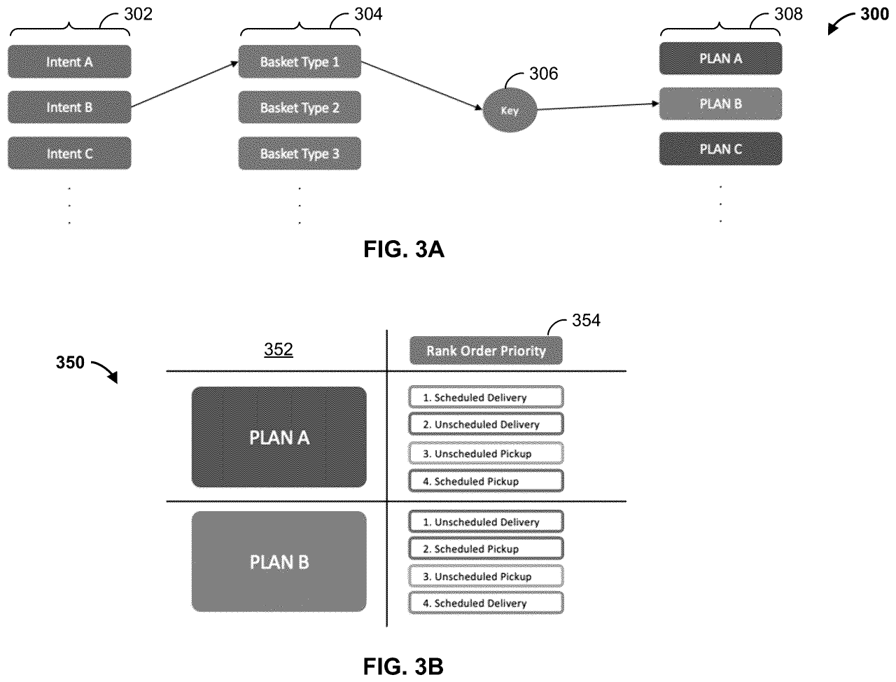

FIG. 3A is a diagram 300 illustrating a mapping of basket types 304 to fulfillment plans 308 based on determined customer intents 302. Each customer intent 302 may be an explicit intent (e.g., one selected by the customer, such as a selection of a delivery date for the order), or an implicit intent (e.g., one determined by item fulfillment computing device 102 based on, for example, previous transactions made by the customer and the items currently being purchased).

For example, item fulfillment computing device 102 may determine an implicit intent of the customer based on past customer orders and recent customer actions on a retailer's website and/or executed applications (“Apps”). In some examples, item fulfillment computing device 102 determines the implicit intent is based on a set of deterministic rules, while in other examples item fulfillment computing device 102 applies a prediction model, such as one based on one or more machine learning models, to determine the implicit intent. As an example of a set of deterministic rules, item fulfillment computing device 102 may apply the following. By default, item fulfillment computing device 102 may determine and use the customer's last order intent if one is available. If no information is available for the customer, then item fulfillment computing device 102 defaults to using shipping as the customer's intent. Further, when the customer takes action, item fulfillment computing device 102 continues to predict and change intent. For instance, if the customer changes a store location, item fulfillment computing device 102 sets the customer's default intent to pick up. If the customer changes a search filter on the retailer's website, item fulfillment computing device 102 sets the customer's default intent based on the new filter. If the customer adds an address (e.g., to their online retailer's account, or a shipping address), item fulfillment computing device 102 sets the customer's intent to delivery. In some examples, item fulfillment computing device 102 sets the customer's intent to delivery if the updated address is more than a predetermined distance to a nearest retail location. Otherwise, item fulfillment computing device 102 sets the customer's intent to pick up (e.g., from the nearest retail location).

Further, each basket type 304 may correspond to the types of items that may be placed in a basket (e.g., checkout cart). For example, a first basket type may correspond to a cart that includes shared items (e.g., items that are available at a retail location and that can also be shipped), store only items (e.g., items that cannot be shipped but are available at a retail location), and shipping only items (e.g., items that can be shipped but that are not available at a retail location). A second basket type may correspond to a cart that includes only shared items. Further, a third basket type may correspond to a cart that includes only store only items, while a fourth basket type may correspond to a cart that includes only shipping only items. Key 306 may determine a fulfillment plan 308 based on a customer intent 302 and a basket type 304. For instance, key 306 may map the particular customer intent 302 and the basket type 304 to one of the fulfillment plans 308.

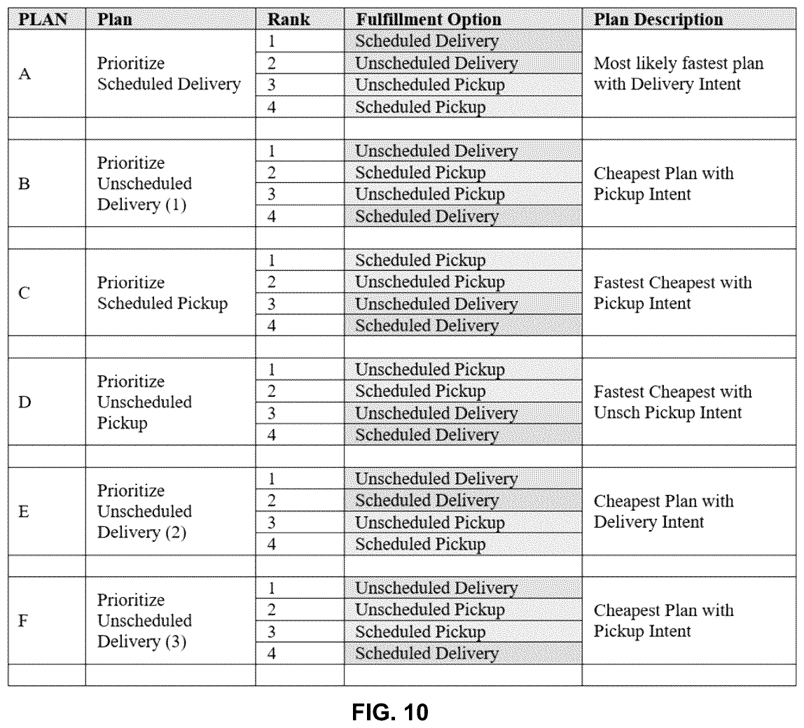

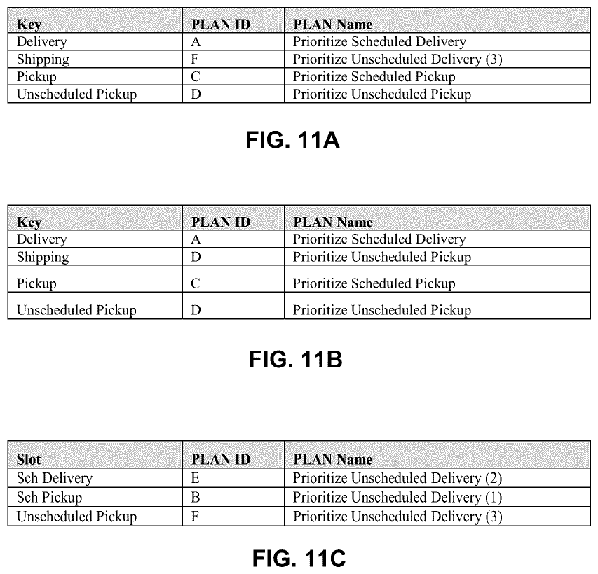

For instance, FIGS. 11A, 11B, and 11C illustrate key mapping tables, which map a key, such as Delivery, Shipping, Pickup, and Unscheduled Pickup, to a fulfillment plan. For instance, and as illustrated in FIG. 11A, the Delivery key is mapped to a plan A. Further, the Shipping key is mapped to a plan F, the Shipping key is mapped to a plan C, and the Unscheduled Pickup key is mapped to a plan D. FIGS. 11B and 11C illustrate their own mapping. In some examples, the key mapping table of FIG. 11B is used for the Store Module, while the key mapping table of FIG. 11C is used for an Intent-Slot mismatch. The plans may correspond to the plans of FIG. 10, as described herein.

As illustrated in FIG. 3B, each fulfillment plan 352 (equivalent to each of the fulfillment plans 308 of FIG. 3A) may include a ranked order of fulfillment priorities. For instance, “Plan A” may have a ranked order of fulfillment priorities including, as ranked, scheduled delivery, unscheduled delivery, unscheduled pickup, and scheduled pickup. “Plan B,” however, may have a ranked order of fulfillment priorities including, as ranked, unscheduled delivery, scheduled pickup, unscheduled pickup, scheduled delivery

The various fulfillment options may be defined, for instance, as follows: Scheduled Delivery—time slotted Delivery from Delivery Store done by Last Mile Delivery carriers; Unscheduled Delivery—un-slotted Delivery done via National Carrier or Last Mile Delivery Carriers from the local delivery store; Scheduled Pickup—time slotted curbside pickup; and Unscheduled Pickup—either curbside or in-store pickup with no specific time slot but a general time frame (e.g., such as starting from 3 hours from order placement to up to 7 days).

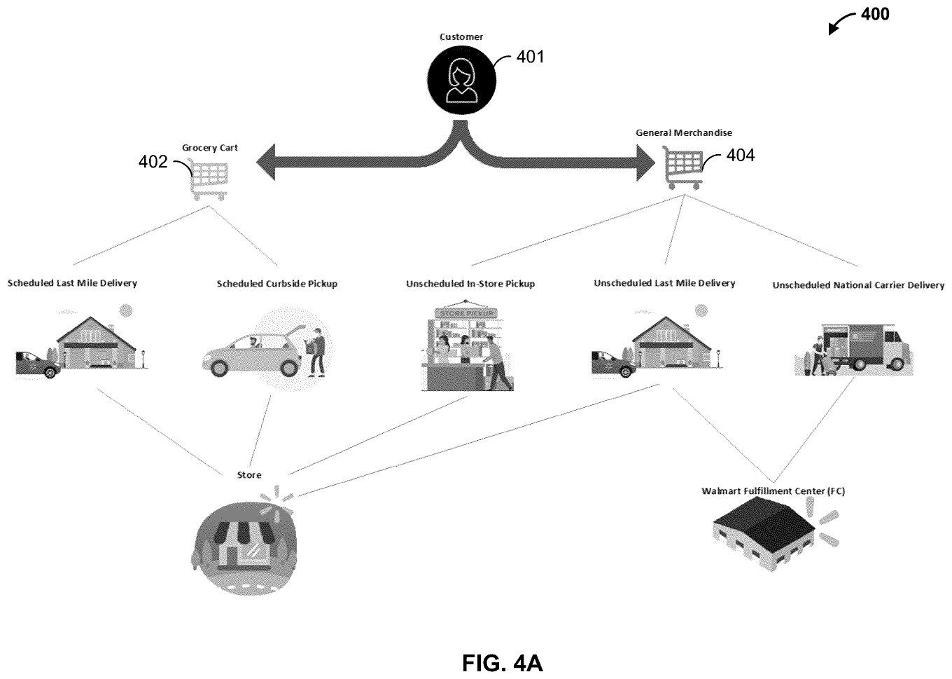

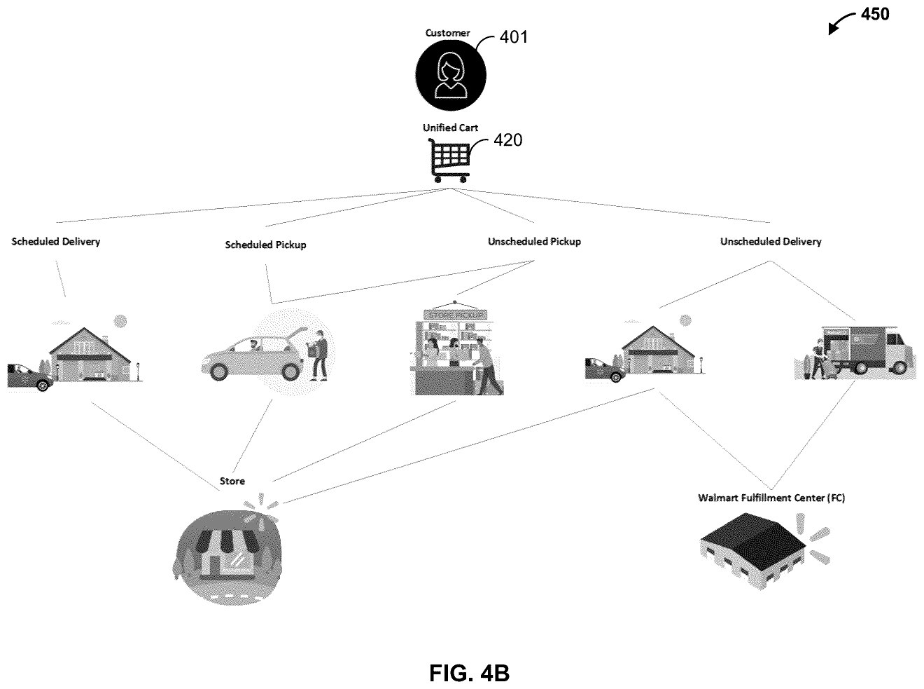

FIG. 4A illustrates a conventional system 400 that uses conventional fulfillment options for grocery items in a grocery cart 402 and GM items in a GM cart 404. For instance, customer 401 may purchase grocery items that are placed in grocery cart 402. The customer 401 may then be provided with scheduled delivery and scheduled pickup options. GM items that are purchased are placed in the GM cart 404. The customer may then be provided with unscheduled in-store pickup, unscheduled retailer delivery, and unscheduled national carrier delivery options.

In contrast, FIG. 4B illustrates a fulfillment system 450 where all items purchased by the customer 401, including grocery and GM items, are placed in a unified cart 420. Based on the items and an intent of the customer, item fulfillment computing device 102 determines one or more of a scheduled delivery, scheduled pickup, unscheduled pickup, and unscheduled delivery fulfillment options for the items. Thus, in contrast with placing grocery items in one cart, GM items in another cart, and providing fulfillment options for each, the fulfillment system 450 places all items, including a combination of the grocery and GM items, in a single unified cart 420, and automatically determines fulfillment options for the items.

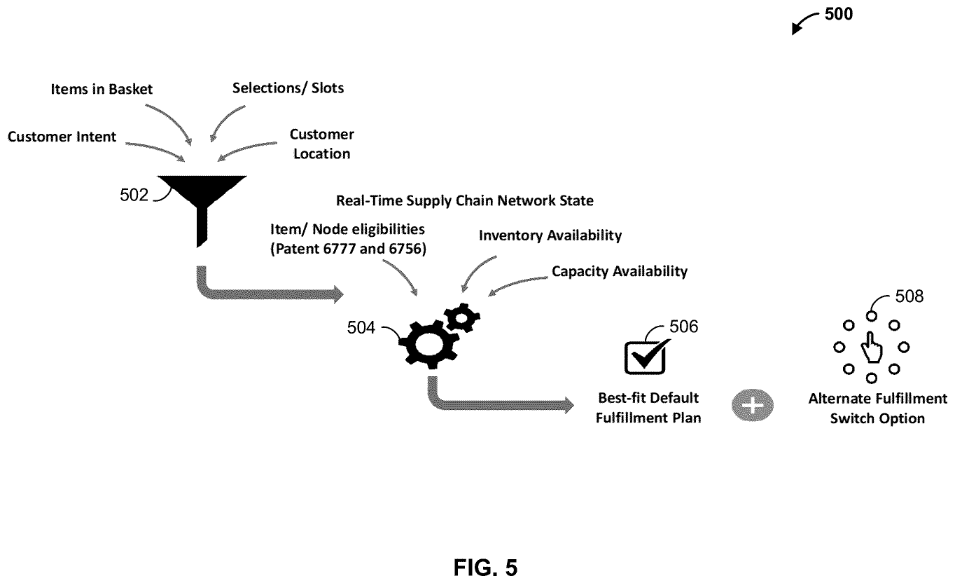

FIG. 5 is a diagram 500 illustrating the determination of fulfillment options based on various customer and transaction data 502, as well as supply chain data 504. For instance, customer and transaction data 502 may include one or more of items in a basket (e.g., items in a current online cart), an explicit or implicit intent, a timeslot selection (e.g., timeslot selected by the customer for delivery or pickup), and a customer location. Further, the supply chain data 504 may include item inventory availabilities (e.g., whether available to ship or pick up at a retail location), item types, and capacity availabilities (e.g., capabilities of delivery trucks for delivery, etc.). Based on customer and transaction data 502 and supply chain data 504, item fulfillment computing device 102 may determine a best-fit default fulfillment plan 506, which identifies one or more fulfillment options for items in the basket. Further, in some examples, item fulfillment computing device 102 determines an alternate fulfillment option 508 for the items in the basket. The alternate fulfillment option 508 may be one that the customer may switch to (e.g., from the best-fit default fulfillment plan 506), as described herein.

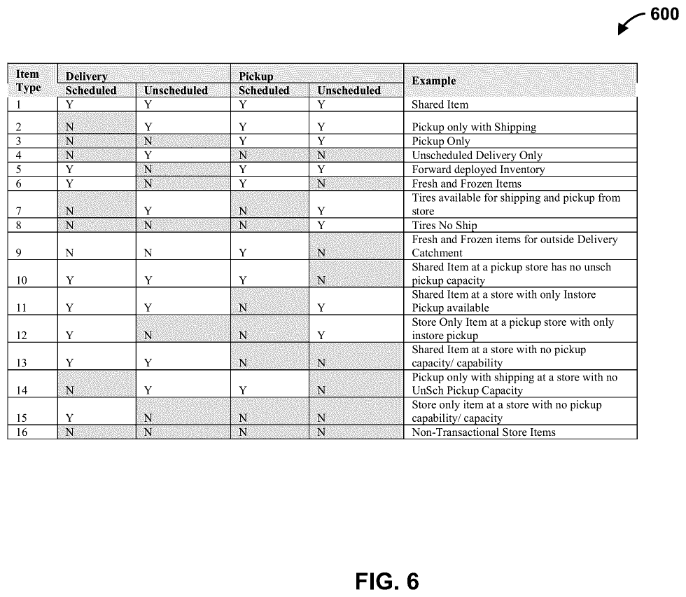

FIG. 6 illustrates a table 600 that identifies delivery and pickup options for each of various item types (e.g., types of grocery items, types of GM items, etc.). With the inclusion of various store types with varying access type capabilities, the items have varying fulfillment options due to varying constraints on capacity, access types, and eligibility. Table 600 includes sixteen item groups. For instance, consider diapers offered to a customer located in San Jose, CA. Assume the inventory is available at a San Jose store as well as at a servicing fulfillment center. In this case, all four exemplary fulfillment options—Scheduled Delivery, Scheduled Pickup, Unscheduled Delivery, and Unscheduled Pickup—can be offered to the customer. Such an item will fall in Item group 1 of table 600.

In some examples, and as described herein, a customer is offered fulfillment switch options (e.g., via a checkout page of a retailer's website), which a customer may select to “switch” the current fulfillment option for an order. For instance, in some examples, a fulfillment switch option may include a “Store Module,” which may include items defaulted to the Scheduled Pickup or Scheduled Delivery options. In some examples, a fulfillment switch option may include a “Shipping Module,” which may include items defaulted to the unscheduled delivery option. Further, in some examples, a fulfillment switch option may include an “Unscheduled Pickup Module,” which may include items defaulted to unscheduled pickup. For example tires, which can have a requirement to be defaulted to unscheduled pickup, may be defaulted to the “Unscheduled Pickup Module.” Further, an “e-Delivery Module” may include items that are delivered electronically, such as over e-mail or SMS, and may include products such as e-gift cards, software, pre-paid e-cards, electronic gift cards, and the like.

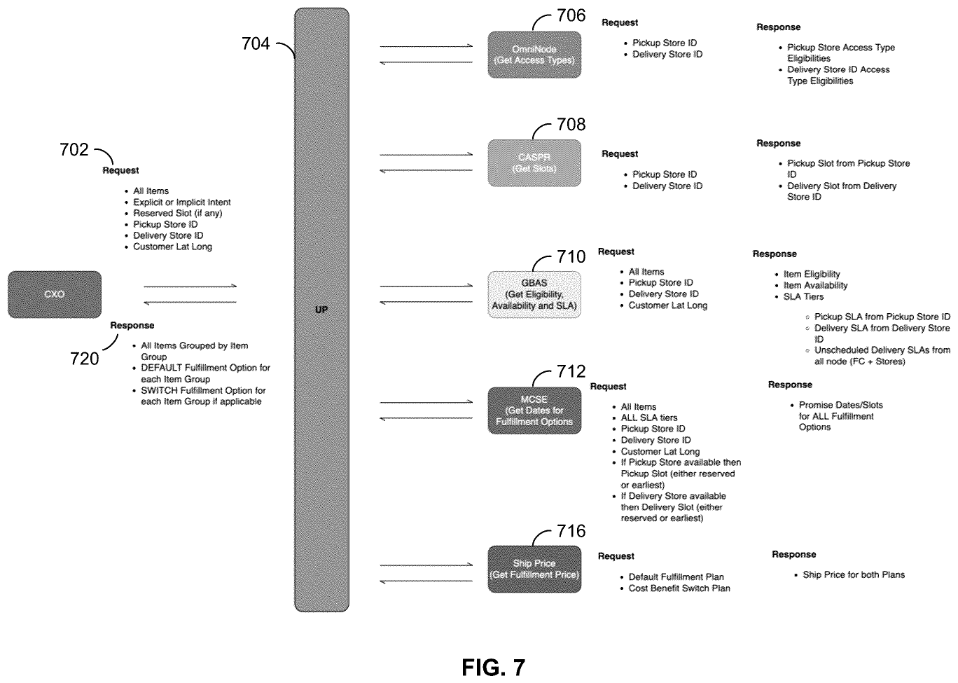

FIG. 7 illustrates a block diagram of functional modules that can be implemented by item fulfillment computing device 102 to determine fulfillment options for a customer. In some examples, the functional modules are implemented as executable instructions stored in instruction memory 207, and are executed by one or more processors 201. In this example, Unified Promise (UP) module 704 takes in all signals on explicit and implicit intent passed by a front end. Further, downstream systems including GBAS (Geo-Based Availability Service) module 710, MCSE (Multi-Channel Sourcing Engine) module 712, SP (Ship Price) module 714, OmniNode module 706, and CASPr (Capacity and Slot Promise) module 708 perform operations with no regards for intent. The UP module 704 will marry intent to the generic response derived from the downstream systems to furnish the desired fulfillment option to a Cart and Checkout (CXO) module (not illustrated). In this example, MCSE module 712 evaluates all fulfillment options and then UP module 704 executes the defaulting and switching rules and/or algorithms to return only desired fulfillment plans to the CXO module.

As an example, UP module 704 may receive from CXO module all items for an order in a basket (e.g., online cart), an explicit or implicit intent for the order, a customer selected time slot, a pickup store ID, and a delivery store ID. UP module 704 may receive from the GBAS module 710 an item eligibility, an item availability, and service level agreement (SLA) Tier information. The SLA Tier information may include Pickup SLA from Pickup Store ID, Scheduled Delivery SLA from Delivery Store ID, and Unscheduled Delivery SLAs from all fulfillment centers and stores. UP module 704 may also receive, from OmniNode module 706, store access type eligibility, and from the CASPR module 708, time slot availability, one or more delivery slots for Delivery Store ID, and one or more pickup slots for Pickup Store ID.

UP module 704 may form Item Groups by common fulfillment options such as, for instance, according to item types, such as the item types illustrated in table 600. UP module 704 may determine whether a customer selected time slot is available. If there is no customer reserved time slot available, then UP module 704 will determine the earliest available time slot. UP module 704 may then generate a message that includes, for instance, the Item Groups, any selected time slot, and any earliest available time slot if there is no selected time slot. UP module 704 may transmit the message to MCSE module 712 to evaluate all fulfillment options, including, for example, Scheduled Delivery, Unscheduled Delivery, Scheduled Pickup, and Unscheduled Pickup, wherever applicable (e.g., for each item).

MCSE module 712 can solve for all fulfillment options and return solutions at offer level. UP module 704 may execute Defaulting Logic to generate a best fit fulfillment plan for the order. Further, UP module 704 may execute Switching Logic to identify a fulfillment switch, if applicable, for each Item Group. UP module 704 may then generate and send a message to SP module 714 with a default basket (i.e., default fulfillment option) and, in some examples, a switch basket (i.e., an alternate fulfillment option that the customer can switch to).

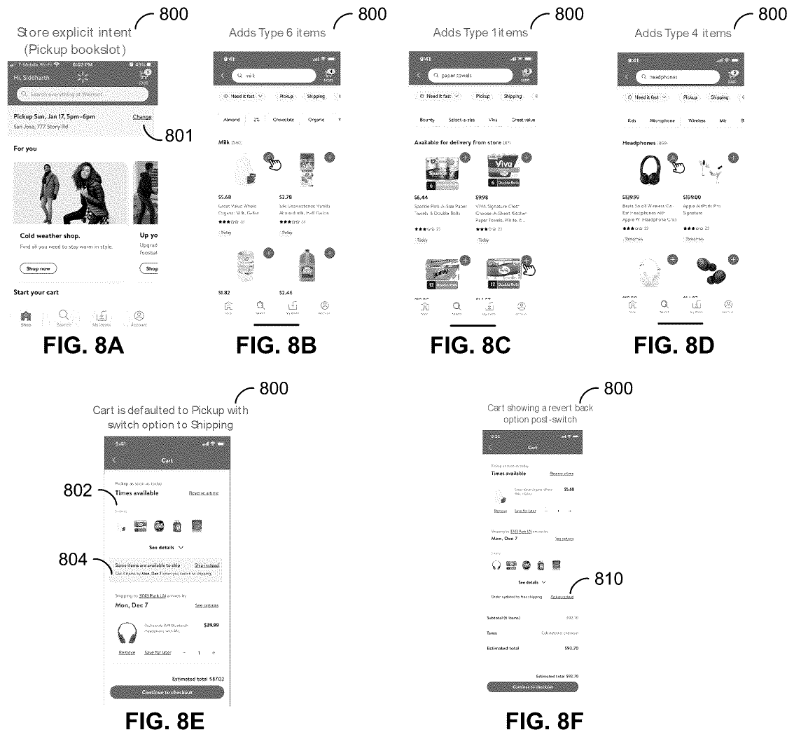

FIGS. 8A, 8B, 8C, 8D, 8E, and 8F illustrate portions of a webpage 800 during a purchase and checkout process. For example, FIG. 8A illustrates a pickup time slot that has been established by the customer, and which the customer can change by engaging change icon 801. Because the customer has established the pickup time slot, item fulfillment computing device 102 determines a store pickup explicit intent. As illustrated in FIG. 8B, the customer adds “type 6” items (e.g., type 6 according to table 600) to an online shopping cart. Further, as illustrated in FIG. 8C, the customer adds “type 1” items to the online shopping cart. Likewise, as illustrated in FIG. 8D, the customer adds “type 4” items to the online shopping cart. Based on the “type 6, type 4,” and “type 1” items 802 in the online shopping cart, item fulfillment computing device 102 defaults the online shopping cart to pick up with a switch option 804 to shipping. If the customer were to select the switch option 804, the customer still has the option of reverting back to the original fulfillment option, as illustrated in FIG. 8F with the revert option 810 (i.e., “Pickup instead”).

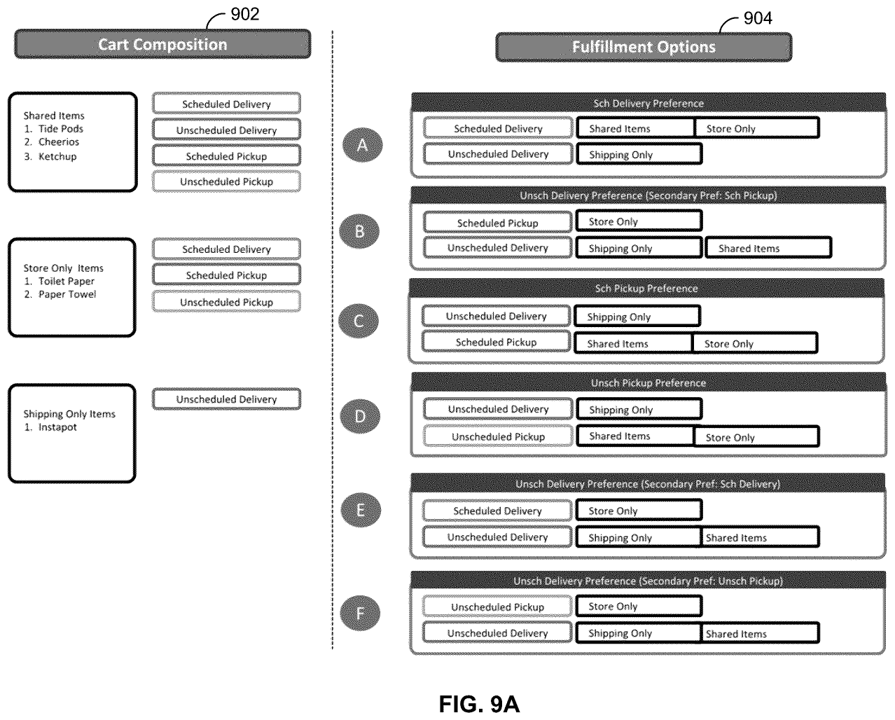

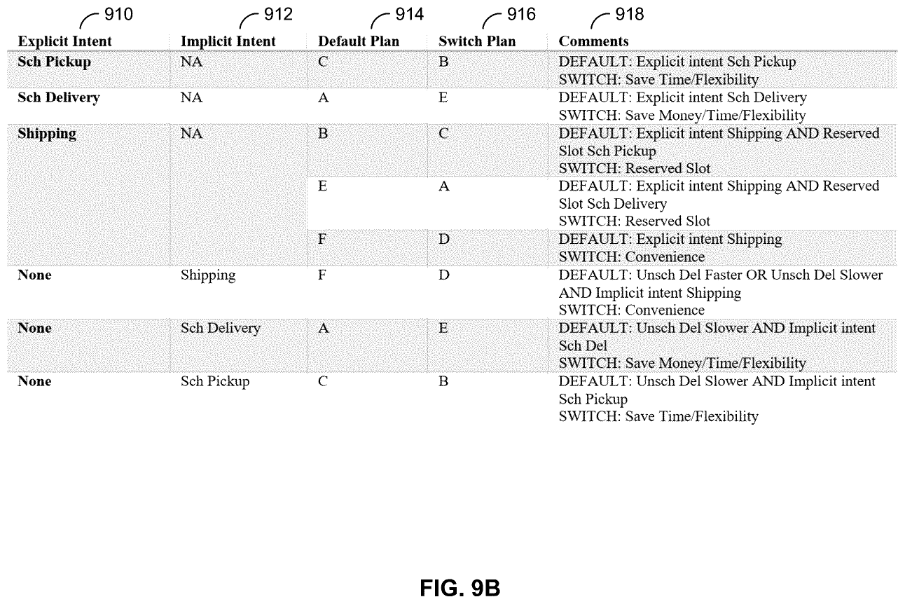

FIG. 9A illustrates multiple ways in which the same basket of items can be fulfilled. For instance, assume a cart composition 902 that includes shared items, store only items, and shipping only items. Shared items may be fulfilled by Scheduled Delivery, Unscheduled Delivery, Scheduled Pickup, and Unscheduled Pickup. Store only items may be fulfilled by Scheduled Delivery, Scheduled Pickup, and Unscheduled Pickup. Finally, shipping only items may be fulfilled by Unscheduled Delivery only. FIG. 9A illustrates fulfillment options 904 for each of fulfillment plans A though F. For example, fulfillment plan A may include a Scheduled Delivery for shared items and store only items, and include an Unscheduled Delivery for shipping only items. Each of the remaining fulfillment plans B-F have corresponding fulfillment options 904 as illustrated.

FIG. 9B illustrates possible fulfillment plan options based on the cart composition 902, which includes shared items, store only items, and shipping only items. For instance, and assuming an explicit intent 910 of Schedule Pickup, item fulfillment computing device 102 may determine plan C as the default plan 914, and plan B as the switch plan 916. Comments 918 lists comments for each plan. Similarly, and assuming an explicit intent 910 of Scheduled Delivery, item fulfillment computing device 102 may determine plan A as the default plan 914, and plan E as the switch plan 916. Further, and assuming an explicit intent 910 of Shipping, item fulfillment computing device 102 may determine plan B as the default plan 914, and plan C as the switch plan 916. In some examples, item fulfillment computing device 102 may determine plan E as the default plan 914, and plan A as the switch plan 916. In other examples, item fulfillment computing device 102 may determine plan F as the default plan 914, and plan D as the switch plan 916.

In the event there is no explicit intent 910, item fulfillment computing device 102 may determine an implicit intent 912 as described herein. Further, and based on the implicit intent 912, item fulfillment computing device 102 may determine a default plan 914 and a switch plan 916. For instance, assuming an implicit intent 912 of Shipping, item fulfillment computing device 102 may determine plan F as the default plan 914, and plan D as the switch plan 916. If the implicit intent 912 is Scheduled Delivery, item fulfillment computing device 102 may determine plan A as the default plan 914, and plan E as the switch plan 916. Further, if the implicit intent 912 is Scheduled Pickup, item fulfillment computing device 102 may determine plan C as the default plan 914, and plan B as the switch plan 916.

FIG. 10 illustrates a ranking of fulfillment options for each of plans A through F. For instance, and with reference to Plan A (“Prioritized Scheduled Delivery”), the plan ensures, for example, that all items that can be fulfilled using a Rank 1 Fulfillment Option, which is Scheduled Delivery for Plan A, are assigned to that option. Items that cannot be fulfilled using the Rank 1 Fulfillment Option, but that can be fulfilled using the Rank 2 Fulfillment Option, which is Unscheduled Delivery for Plan A, get assigned to that option. Similarly, items that cannot be fulfilled using the Rank 2 Fulfillment Option, but that can be fulfilled using the Rank 3 Fulfillment Option, are assigned to that option. Items that cannot be fulfilled using the Rank 3 Fulfillment Option are assigned to the Rank 4 Fulfillment Option. Plans B, C, D, E, and F each have their own ranking, as illustrated

In some examples, a method by a computing device, such as by item fulfillment computing device 102, includes receiving a request identifying a plurality of items for an order of a customer. The method includes determining, for each of the plurality of items, at least one fulfillment option. Based on the at least one fulfillment options for each of the plurality of items and an intent of the customer, the method includes determining a first fulfillment option for the order. Further, the method includes providing the first fulfillment option for the order for display.

In some examples, the method includes determining a second fulfillment based on the at least one fulfillment options for each of the plurality of items, the intent of the customer, and the first fulfillment option. The method may also include providing the second fulfillment option for display. In some examples, the method includes receiving a selection of at least one of the first fulfillment option and the second fulfillment option. The method may also include generating a fulfillment selection message identifying an item fulfillment option for the plurality of items based on the selection of the at least one of the first fulfillment option and the second fulfillment option. Further, the method may include transmitting the fulfillment selection message to another computing device for fulfillment of the order.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a non-transitory computer-readable medium having instructions stored thereon; and
a processor configured to read the instructions to:
receive a request for a fulfillment interface, wherein the request identifies a plurality of items for an order, wherein the request for the fulfillment interface is received from a first device;
determine, for each of the plurality of items, at least one available fulfillment option;
generate a first fulfillment plan including a first fulfillment option for a first set of items in the plurality of items and a second fulfillment option for a second set of items in the plurality of items, wherein the first fulfillment option and the second fulfillment option are generated based on the at least one available fulfillment option of each of a corresponding set of items and a customer intent;
generate the fulfillment interface including the first fulfillment plan, wherein the fulfillment interface includes a first portion identifying the first fulfillment option and each of the first set of items and a second portion identifying the second fulfillment option and each of the second set of items; and
transmit the fulfillment interface including the first fulfillment plan to the first device for display.

2. The system of claim 1, wherein the processor is configured to determine a second fulfillment plan including a third fulfillment option for a third set of items, wherein the third set of items includes at least one item selected from the first set of items and at least one item selected from the second set of items, wherein the second fulfillment plan is generated based on the at least one available fulfillment option for each of the plurality of items, the customer intent, and the first fulfillment option.

3. The system of claim 2, wherein the fulfillment interface is configured to display a selected one of the first fulfillment plan or the second fulfillment plan, wherein the fulfillment interface is configured to display the first portion and the second portion when the first fulfillment plan is selected, and wherein the fulfillment interface is configured to display the a third portion including the third fulfillment option and the third set of items when the second fulfillment plan is selected.

4. The system of claim 3, wherein the processor is configured to receive a selection of the first fulfillment plan or the second fulfillment plan.

5. The system of claim 4, wherein the processor is configured to:
generate a fulfillment selection message identifying the selection of the first fulfillment plan or the second fulfillment plan; and
transmit the fulfillment selection message to a second computing device configured to cause fulfillment of the order.

6. The system of claim 1, wherein the first fulfillment option and the second fulfillment option are selected based on a predetermined ranking of fulfillment options for the customer intent.

7. The system of claim 1, wherein the customer intent is an explicit intent, and wherein the processor is configured to receive the explicit intent from the first device.

8. The system of claim 1, wherein the customer intent is an implicit intent, and wherein the processor is configured to generate the implicit intent based on the plurality of items and historic order data associated with the first device.

9. A computer-implemented method, comprising:
receiving a request for a fulfillment interface, wherein the request identifies a plurality of items for an order, wherein the request for the fulfillment interface is received from a first device;
determining, for each of the plurality of items, at least one available fulfillment option;
generating a first fulfillment plan including a first fulfillment option for a first set of items in the plurality of items and a second fulfillment option for a second set of items in the plurality of items, wherein the first fulfillment option and the second fulfillment option are generated based on the at least one available fulfillment option of each of a corresponding set of items and a customer intent;
generating the fulfillment interface including the first fulfillment plan, wherein the fulfillment interface includes a first portion identifying the first fulfillment option and each of the first set of items and a second portion identifying the second fulfillment option and each of the second set of items; and
transmitting the fulfillment interface including the first fulfillment plan to the first device for display.

10. The computer-implemented method of claim 9, comprising determining a second fulfillment plan including a third fulfillment option for a third set of items, wherein the third set of items includes at least one item selected from the first set of items and at least one item selected from the second set of items, wherein the second fulfillment plan is generated based on the at least one available fulfillment option for each of the plurality of items, the customer intent, and the first fulfillment option, wherein the fulfillment interface is configured to display a selected one of the first fulfillment plan or the second fulfillment plan, wherein the fulfillment interface is configured to display the first portion and the second portion when the first fulfillment plan is selected, and wherein the fulfillment interface is configured to display the a third portion including the third fulfillment option and the third set of items when the second fulfillment plan is selected.

11. The computer-implemented method of claim 10, comprising:
receiving a selection of at least one of the first fulfillment plan or the second fulfillment plan;
generating a fulfillment selection message identifying the selection of the first fulfillment plan or the second fulfillment plan; and
transmitting the fulfillment selection message to a second computing device configured to cause fulfillment of the order.

12. The computer-implemented method of claim 9, wherein the first fulfillment option and the second fulfillment option are selected based on a predetermined ranking of fulfillment options for the customer intent.

13. The computer-implemented method of claim 9, wherein the customer intent is an explicit intent received from the first device.

14. The computer-implemented method of claim 9, wherein the customer intent is an implicit intent generated based on the plurality of items and historic order data associated with the first device.

15. A non-transitory computer-readable medium having instructions stored thereon, wherein the instructions, when executed by at least one processor, cause a device to perform operations comprising:
receiving a request for a fulfillment interface, wherein the request identifies a plurality of items for an order, wherein the request for the fulfillment interface is received from a first device;
determining, for each of the plurality of items, at least one available fulfillment option;
generating a first fulfillment plan including a first fulfillment option for a first set of items in the plurality of items and a second fulfillment option for a second set of items in the plurality of items, wherein the first fulfillment option and the second fulfillment option are generated based on the at least one available fulfillment option of each of a corresponding set of items and a customer intent;
generating the fulfillment interface including the first fulfillment plan, wherein the fulfillment interface includes a first portion identifying the first fulfillment option and each of the first set of items and a second portion identifying the second fulfillment option and each of the second set of items; and
transmitting the fulfillment interface including the first fulfillment plan to the first device for display.

16. The non-transitory computer-readable medium of claim 15, wherein the processor causes the device to perform operations comprising determining a second fulfillment plan including a third fulfillment option for a third set of items, wherein the third set of items includes at least one item selected from the first set of items and at least one item selected from the second set of items, wherein the second fulfillment plan is generated based on the at least one available fulfillment option for each of the plurality of items, the customer intent, and the first fulfillment option, wherein the fulfillment interface is configured to display a selected one of the first fulfillment plan or the second fulfillment plan, wherein the fulfillment interface is configured to display the first portion and the second portion when the first fulfillment plan is selected, and wherein the fulfillment interface is configured to display the a third portion including the third fulfillment option and the third set of items when the second fulfillment plan is selected.

17. The non-transitory computer-readable medium of claim 16, wherein the processor causes the device to perform operations comprising:
receiving a selection of at least one of the first fulfillment plan or the second fulfillment plan;
generating a fulfillment selection message identifying the selection of the first fulfillment plan or the second fulfillment plan; and
transmitting the fulfillment selection message to a second computing device configured to cause fulfillment of the order.

18. The non-transitory computer-readable medium of claim 15, wherein the first fulfillment option and the second fulfillment option are selected based on a predetermined ranking of fulfillment options for the customer intent.

19. The non-transitory computer-readable medium of claim 15, wherein the customer intent is an explicit intent received from the first device.

20. The non-transitory computer-readable medium of claim 15, wherein the customer intent is an implicit intent generated based on the plurality of items and historic order data associated with the first device.
